(19) United States
(12) Patent Application Publication
(10) Pub. No.: US 2025/0036462 A1
(43) Pub. Date: Jan. 30, 2025

(54) METHODS AND APPARATUS FOR MULTILEVEL BALANCING OF COMPUTATIONAL TASKS

(71) Applicant: The Boeing Company, Arlington, VA (US)

(72) Inventors: Benjamin Horn Oster, Wynnewood, PA (US); Justin Taylor Terek, Philadelphia, PA (US)

(21) Appl. No.: 18/358,211

(22) Filed: Jul. 25, 2023

(51) Int. Cl. G06F 9/48

(52) U.S. Cl. CPC G06F 9/4881

(57) ABSTRACT

Methods and apparatus are disclosed for multilevel balancing of computational tasks, the multilevel balancing including interface circuitry to receive or access a batch of tasks; machine readable instructions; and programmable circuitry to at least one of instantiate or execute the machine readable instructions to allocate the batch of computational tasks into sets, distribute the sets to compute nodes, monitor the compute nodes for completion of the computational tasks, distribute ones of the computational tasks to computational resources of the respective compute nodes based on the monitoring of the completion of the computational tasks, monitor the compute nodes for completion of respective ones of the sets, distribute queued sets to the compute nodes based on the monitoring of the completion of the sets, and distribute queued tasks to the computational resources based on the monitoring of the completion of the tasks.

### STATEMENT OF GOVERNMENT INTEREST

This invention was made with Government support under AMTC 19-08-024 awarded by DEPARTMENT OF DEFENSE. The government has certain rights in this invention.

### FIELD OF THE DISCLOSURE

This disclosure relates generally to distributed computing and, more particularly, methods and apparatus for multilevel balancing of computational tasks.

### BACKGROUND

Computationally intensive operations, such as simulations for example, can necessitate a significant amount of computational tasks, which can be run in a generally parallel manner so that the computational tasks can be completed in a reasonable amount of time. Particularly, distributed computing systems have been employed to distribute and/or balance computational tasks between compute nodes thereof. To that end, load balancing algorithms have been employed to direct distribution of the computational tasks between the aforementioned compute nodes.

### SUMMARY

An example apparatus for multilevel distribution of computational tasks includes interface circuitry to receive or access a batch of the computational tasks, machine readable instructions, and programmable circuitry to at least one of instantiate or execute the machine readable instructions to allocate the batch of the computational tasks into sets, distribute the sets to compute nodes, monitor the compute nodes for completion of the computational tasks, distribute ones of the computational tasks to computational resources of the respective compute nodes based on the monitoring of the completion of the computational tasks, monitor the compute nodes for completion of respective ones of the sets, distribute queued sets to the compute nodes based on the monitoring of the completion of the sets, and distribute queued tasks to the computational resources based on the monitoring of the completion of the tasks.

An example non-transitory machine readable storage medium includes instructions to cause programmable circuitry to at least allocate a batch of computational tasks into sets, distribute the sets to compute nodes, monitor the compute nodes for completion of the computational tasks, distribute ones of the computational tasks between computational resources of the respective compute nodes based on the monitoring of the completion of the computational tasks, monitor the compute nodes for completion of respective ones of the sets, distribute queued sets to the compute nodes based on the monitoring of the completion of the sets, and distribute queued tasks to the computational resources based on the monitoring of the completion of the tasks.

An example method for multilevel distribution of computational tasks includes dividing, by executing instructions with programmable circuitry, a batch of the computational tasks into sets, distributing, by executing instructions with the programmable circuitry, the sets to compute nodes, monitoring, by executing instructions with the programmable circuitry, the compute nodes for completion of the computational tasks distributing, by executing instructions with the programmable circuitry, ones of the computational tasks between computational resources of the respective compute nodes based on the monitoring of the completion of the computational tasks monitoring, by executing instructions with the programmable circuitry, the compute nodes for completion of respective ones of the sets, distributing, by executing instructions with the programmable circuitry, queued sets to the compute nodes based on the monitoring of the completion of the sets, and distributing, by executing instructions with the programmable circuitry, queued tasks to the computational resources based on the monitoring of the completion of the tasks.

### BRIEF DESCRIPTION OF THE DRAWINGS

FIG. 1 is a schematic diagram of an example environment in which examples disclosed herein can be implemented.

FIG. 2 is an example process flow to balance computational tasks structured in accordance with teachings of this disclosure.

FIG. 3 is a block diagram of example controller circuitry that can be implemented in examples disclosed herein.

FIGS. 4 and 5 are flowcharts representative of example machine readable instructions and/or example operations that may be executed, instantiated, and/or performed by example programmable circuitry to implement the controller circuitry of FIG. 3.

FIG. 6 is a block diagram of an example processing platform including programmable circuitry structured to execute, instantiate, and/or perform the example machine readable instructions and/or perform the example operations of FIGS. 4 and 5 to implement the controller circuitry of FIG. 3.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 4 and 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein, “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

Methods and apparatus for multilevel balancing of computational tasks are disclosed. In recent years, computational requirements have increased substantially. Therefore, management and/or balancing of performance of the computational tasks (e.g., multiple parallel computational tasks) can be necessitated to ensure completion thereof in a reasonable amount of time. With this significant increase in computational requirements, management of the computational tasks between compute nodes has become more relevant. To that end, examples described herein can advantageously facilitate distribution, balancing, monitoring, and queueing of computational tasks at multiple levels, thereby enabling more efficient utilization of the compute nodes and, thus, relatively quicker completion thereof.

Examples disclosed herein utilize multilevel load balancers to manage computational tasks and/or workloads with respect to compute nodes at intranode and internode levels. Accordingly, examples disclosed herein can manage computational loads at these intranode and internode levels to ensure that overall operations are completed in a relatively time-efficient manner. Examples disclosed herein can also reduce a need for manual user intervention and/or a significant number of user inputs typically necessitated to complete a set of computational tasks (e.g., a batch of computational tasks). Typical approaches require human intervention to manually divide the computational tasks amongst nodes. In contrast, examples disclosed herein can significantly reduce an amount of user input that is typically necessitated for batching and/or distributing computational tasks. As a result, rapid iteration of executing relatively large computational tasks for sets of data (e.g., tasks, jobs, simulations, assignments, etc.) can be completed and analyzed without necessitating significant manual intervention or reconstruction of any subcomponents.

Examples disclosed herein provide a batch of computational tasks to a computing device. In turn, the batch of computing tasks are allocated, distributed, and/or divided into sets, series, and/or arrays. According to examples disclosed herein, the sets are distributed to a cluster and/or a grouping of compute nodes via a head or primary compute node (e.g., a management node, a balancer node, etc.), based on the computational resources of the compute nodes. According to examples disclosed herein, the compute nodes are monitored for completion of the sets. Further, the individual compute nodes monitor completion of the computational tasks of each set assigned and/or provided thereto, and distribute the computational tasks between respective computational resources based on the monitoring of the completion of the computational tasks. In other words, completion of sets assigned to the compute nodes are monitored at the internode level and completion of computational tasks are monitored at the intranode level.

According to examples disclosed herein, the sets are distributed to the cluster of compute nodes based on computational capabilities and/or task handling capabilities of the compute nodes. In some examples, the task handling capabilities correspond to the number of computational tasks the compute nodes can perform during a time period and/or in a relatively simultaneous manner. Additionally, examples disclosed herein evaluate whether a quantity of the sets is greater than a quantity of available compute nodes. Based on a determination that the quantity of sets is greater than the quantity of available compute nodes, a set queue is utilized with queued sets subsequent to the first ones of the sets being distributed to the compute nodes. Examples disclosed herein transfer queued ones of the remainder sets to the compute nodes as the compute nodes become available. Further, some examples disclosed herein provide the compute nodes with remainder sets in a manner that saturates and/or inundates the compute nodes with computational tasks (e.g., based on monitoring of the compute nodes to complete the sets). Based on a determination that the quantity of tasks is greater than the quantity of computational resources available on a compute node, a task queue is utilized with queued tasks subsequent to the first ones of the tasks being distributed to the computational resources.

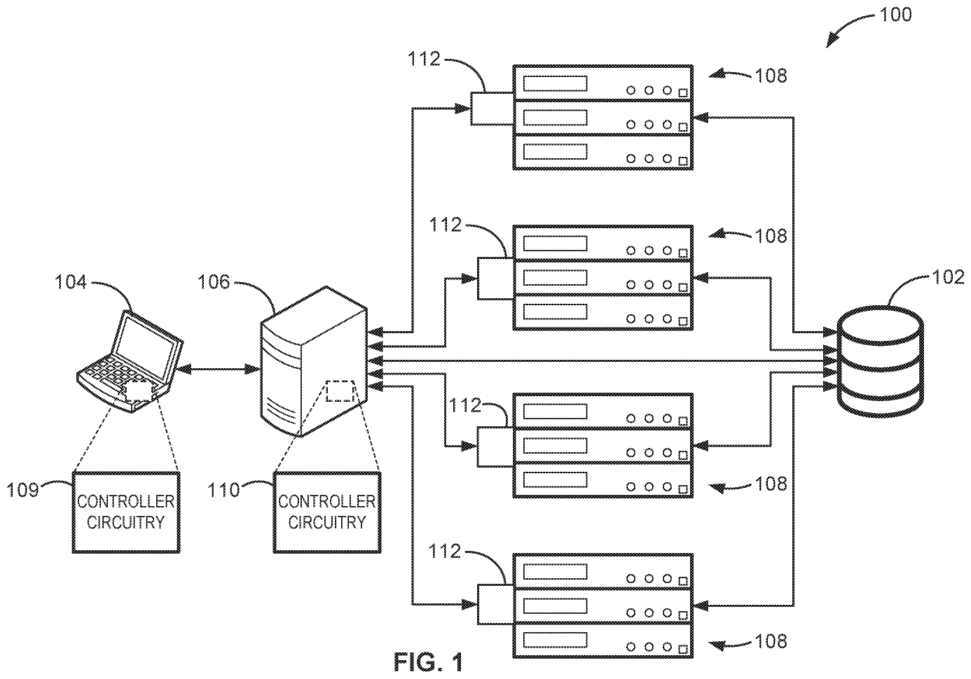

FIG. 1 is a schematic diagram of an example environment 100 in which examples disclosed herein can be implemented. In the illustrated view of FIG. 1, the environment 100 includes an example data storage (e.g., a high performance data storage, a high speed data storage, etc.) 102, an example computing device 104, an example node manager (e.g., a server cluster, a cluster head node, a load manager, a management node, a balancing node, etc.) 106, compute nodes 108, controller circuitry 109, which is implemented in the computing device 104 in this example, controller circuitry 110, which is implemented in the node manager 106 in this example, and compute node controller circuitry 112. However, the controller circuitry 109, the controller circuitry 110, and/or the compute node controller circuitry 112 can be implemented in any appropriate computational device, networked computing system and/or distributed computing system. Additionally or alternatively, the computing device 104 can be integral with the node manager 106 such that the computing device 104 acts with the functionality of the node manager 106, for example. While the illustrated example of FIG. 1 shows a single data storage 102, examples disclosed herein are not limited thereto. For instance, any number and/or type of data storage may be implemented that is communicatively connected to any number and/or type of processor platform(s), either directly and/or via an example network.

The example environment 100 is a distributed computing system in which the controller circuitry 109, controller circuitry 110, and the compute node controller circuitry 112 can be implemented. The example controller circuitry 109 in combination with the compute node controller circuitry 112 mitigates and/or reduces wasteful computational processing typically associated with balancing computational tasks on computer(s). Generally speaking, known approaches necessitate user/human intervention to balance and/or allocate computational tasks into portions. In contrast, examples disclosed herein utilize automated multilevel management of compute nodes to balance computational tasks.

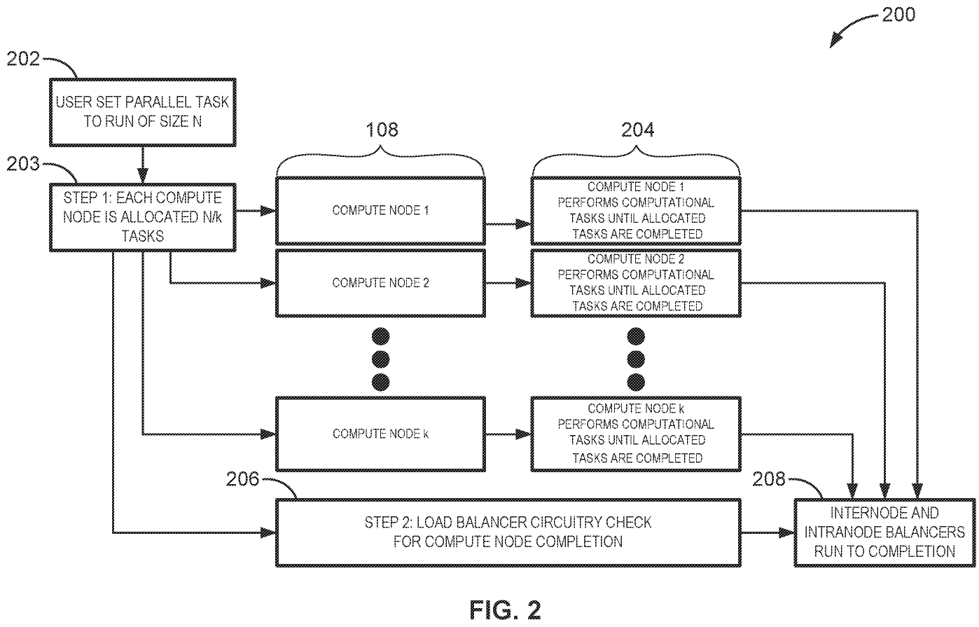

FIG. 2 is an example process flow 200 to balance and/or distribute computational task loads structured in accordance with teachings of this disclosure. At block 202, a user and/or computing system provides and/or defines computational tasks of size N to be performed. In some examples, the user, via the computing device 104 (FIG. 1), provides the maximum number of computational tasks, m, for ones of the compute nodes 108 (FIG. 1) and the number of sets, k. In some examples, the number of sets, k, corresponds to the number of compute nodes 108. In other examples, the number of sets, k, can exceed the number of compute nodes 108. In some example modes of operation, the example controller circuitry 109 allocates, assigns, divides, and/or distributes the batch of computational tasks into corresponding sets, k. In one mode of operation, the example controller circuitry 110 allocates, assigns, divides, and/or distributes the batch of computational tasks into corresponding sets, k. In some examples, the number of computational tasks allocated to each of the sets, k, corresponds to a number of computational tasks that the compute nodes 108 (FIG. 1) can run and/or execute simultaneously, m. For example, if a batch of computational tasks includes a thousand computational tasks and the number of computational tasks the compute node 108 is capable of running simultaneously is one hundred, then the controller circuitry 109 can allocate one hundred computational tasks to ten sets, k. Alternatively, in other examples, if a batch of computational tasks includes a thousand computational tasks and the number of computational tasks the node is capable of running simultaneously is sixty, then the controller circuitry 109 can also allocate one hundred computational tasks to ten sets, k. In this example, the controller circuitry 109 directs performance of the sets of one hundred computational tasks to completion on each of the compute nodes 108. Because the compute nodes 108 of the particular example can handle sixty computational tasks (as opposed to 100 computational tasks) in parallel, a task queue can be initiated, and the first sixty computational tasks will be performed while forty computational tasks are placed in a queue and the first sixty computational tasks are performed.

At block 203, the sets, k, are divided and/or allocated amongst the compute nodes 108 to N computational tasks per sets k, designated as N/k, for example. In some examples, the controller circuitry 109 distributes the sets, k, to the available compute nodes 108 so that the respective compute node controllers 112 can monitor and manage execution of the computational tasks. In some examples, the number of sets, k, is greater than the number of available compute nodes 108. In a particular example, the number of available compute nodes 108 can be four but the number of sets, k, is equal to ten. In such an example, first ones of the sets are distributed to the available compute nodes 108 and the remainder six sets are provided and/or forwarded to a set queue as queued sets. At blocks 204, the compute nodes 108 perform computational tasks, m, in a relatively simultaneous manner and the example compute node controller 112 of each compute node monitors each respective compute node 108 for completion of the computational tasks. In turn, the example compute node controller 112 transfers queued computational tasks (e.g., remainder computational tasks that cannot be simultaneously run at a given moment) to available computing resources (e.g., processors, graphics processing units (GPUs), computational/processor threads, etc.) of each compute node 108 until all computational tasks are completed with respect to the compute node 108. For example, if each compute node 108 is capable of running fifty computational tasks simultaneously and each compute node 108 is allocated one hundred computational tasks assigned by the controller circuitry 110, fifty computational tasks are computed and fifty computational tasks are designated as queued/remained computational tasks (e.g., incomplete computational tasks). In turn, the example compute node controller 112 can distribute the remainder computational tasks to the task queue. According to some other examples disclosed herein, the compute node controller 112 and/or the controller circuitry 109 and/or the controller circuitry 110 will transfer queued computational tasks from one compute node 108 to another of the compute nodes 108 that is available.

At block 206, the controller circuitry 109 monitors and/or determines completion of the sets assigned to the compute nodes 108. In some examples, the number of sets, k, exceeds the number of compute nodes 108 and the controller circuitry 109 transfers and/or distributes remainder sets to the set queue to define queued sets. In some examples, the number of sets, k, exceeds the number of compute nodes 108 and the controller circuitry 110 transfers and/or distributes remainder sets to the set queue to define queued sets. As used herein, the remainder sets can be defined as the sets that exceed the number of available compute nodes 108. In some examples, the controller circuitry 109 transfers the queued sets from the set queue to the compute nodes 108 such that the compute nodes 108 are saturated. In some examples, the controller circuitry 110 transfers the queued sets from the set queue to the compute nodes 108 such that the compute nodes 108 are saturated. As defined herein, the term “saturated” refers to filling the compute nodes 108 with the maximum number (or a number exceeding the maximum number) of computational tasks the compute nodes are capable of running simultaneously as specified or determined by the controller circuitry 109 or by the controller circuitry 110.

At block 208, the example controller circuitry 109 monitors and/or determines completion of an entirety of the sets (e.g., completion of the batch of computational tasks). In some examples, at block 208, the example controller circuitry 110 monitors and/or determines completion of an entirety of the sets (e.g., completion of the batch of the computational tasks). In some examples, the controller circuitry 109 provides an indication that the computational tasks and/or the sets are complete. Additionally or alternatively, the example controller circuitry 110 provides an indication that the computational tasks and/or the sets are complete.

Examples disclosed herein balance computational tasks (e.g., jobs, simulations, etc.) across and within the compute nodes 108 to reduce an overall time necessary for completion thereof. As a result, computational resources can be more efficiently utilized and, thus, resources can be conserved (e.g., power usage can be decreased). Further, examples disclosed herein can reduce user inputs typically necessitated to compute a set of computational tasks, regardless of the amount and/or capabilities of computing devices on a network and/or a distributed computing system.

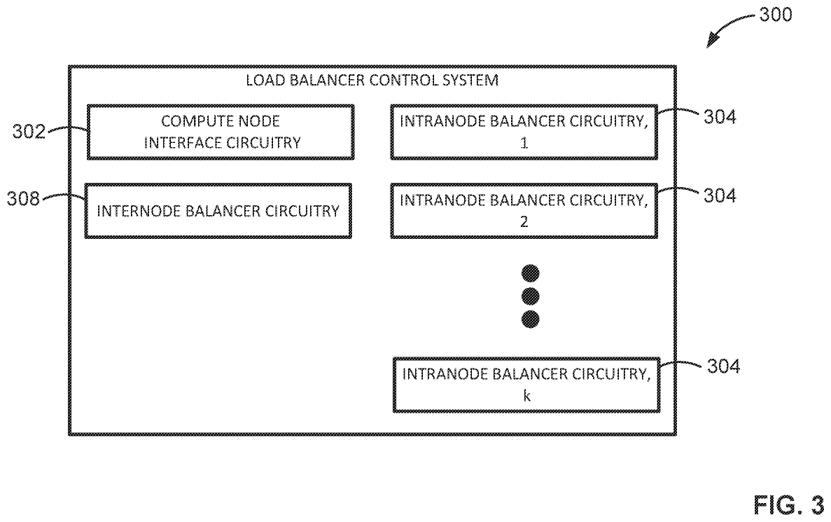

FIG. 3 is a block diagram of an example load balancer control system 300 that can be implemented in examples disclosed herein. The example load balancer control system 300 can be implemented in or with the computing device 104, the controller circuitry 109, the controller circuitry 110, and/or the compute node controller circuitry 112 of FIG. 1, and manages distribution of tasks and/or workloads at intranode and internode levels. The example load balancer control system 300 includes example compute node interface circuitry 302, example intranode balancer circuitry 304, each of which correspond to a respective one of the compute nodes 108 shown in FIGS. 1 and 2, and example internode balancer circuitry 308. The example load balancer control system 300 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the load balancer control system 300 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

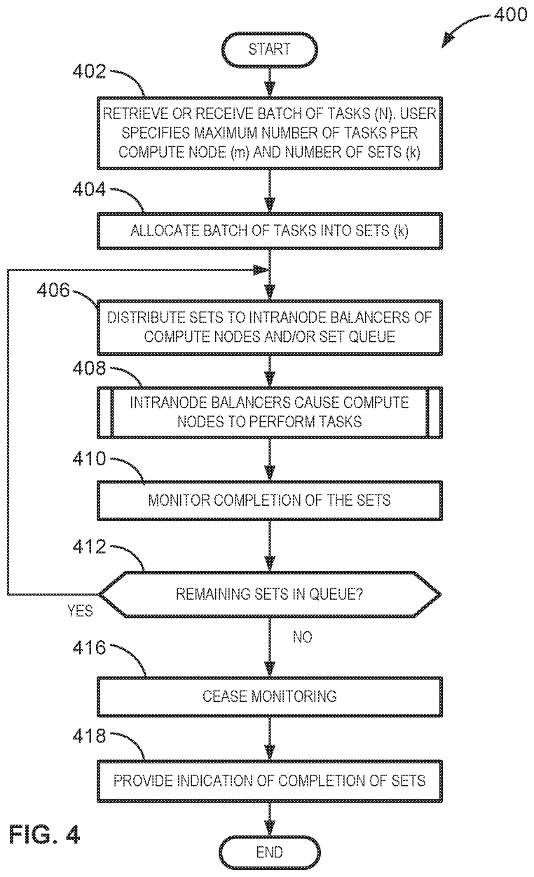

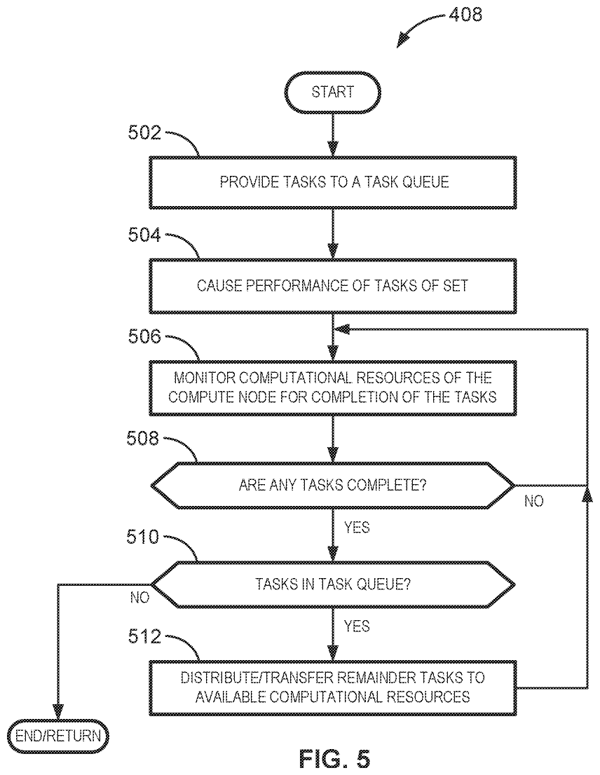

The example load balancer control system 300 includes the compute node interface circuitry 302 that retrieves, receives and/or accesses a batch of computational tasks. In some examples, the compute node interface circuitry 302 receives input from a user corresponding to computational tasks of size, N, to run, a maximum number of computational tasks that can be handled for each compute node (e.g., each of the compute nodes 108 shown in FIG. 1), m, and a number of sets, k. In the illustrated example of FIG. 3, the compute node interface circuitry 302 and/or the example internode balancer circuitry 308 allocates and/or distributes the batch of computational tasks into the sets, k. In turn, the example compute node interface circuitry 302 and/or the example internode balancer circuitry 308 distributes and/or allocates the sets, k, to available compute nodes and if there are remainder sets, the compute node interface circuitry 302 and/or the example internode balancer circuitry 308 distributes the remainder sets to a set queue as queued sets. In some examples, the compute node interface circuitry 302 is instantiated by programmable circuitry executing compute node interface instructions and/or configured to perform operations such as those represented by the flowchart(s) of FIGS. 4 and 5.

The example intranode balancer circuitry 304 can be implemented with respect to individual ones of the compute nodes to monitor completion of the computational tasks of the sets assigned to each compute node. In some examples, the intranode balancer circuitry 304 further directs assignment and/or distribution of the computational tasks within the compute node. In other words, the example intranode balancer circuitry 304 monitors and/or directs usage of the compute node for completion of the computational tasks to balance and/or manage execution of the computational tasks within the compute node. In some examples, the intranode balancer circuitry 304 is instantiated by programmable circuitry executing internode balancer instructions and/or configured to perform operations such as those represented by the flowcharts of FIGS. 4 and 5.

The example internode balancer circuitry 308 monitors the compute nodes (e.g., individual compute nodes) for completion of the sets. For example, the internode balancer circuitry 308 monitors and/or determines when the compute nodes become available to handle additional computational sets, thereby enabling queued sets to be provided to the compute node as the compute nodes become available (e.g., the compute nodes complete computational tasks of prior sets). In some examples, the internode balancer circuitry 308 is instantiated by programmable circuitry executing internode balancer instructions and/or configured to perform operations such as those represented by the flowcharts of FIGS. 4 and 5.

While an example manner of implementing the controller circuitry 109 and/or the controller circuitry 110 of FIG. 1 is illustrated in FIG. 3, one or more of the elements, processes, and/or devices illustrated in FIG. 3 may be combined, divided, re-arranged, omitted, eliminated, and/or implemented in any other way. Further, the example compute node interface circuitry 302, the example intranode balancer circuitry 304, the example internode circuitry 308, and/or, more generally, the example load balancer control system 300 of FIG. 3, may be implemented by hardware alone or by hardware in combination with software and/or firmware. Thus, for example, any of the example compute node interface circuitry 302, the example intranode balancer circuitry 304, the example internode circuitry 308, and/or, more generally, the example load balancer control system 300, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example load balancer control system 300 of FIG. 3 may include one or more elements, processes, and/or devices in addition to, or instead of, those illustrated in FIG. 3, and/or may include more than one of any or all of the illustrated elements, processes and devices.

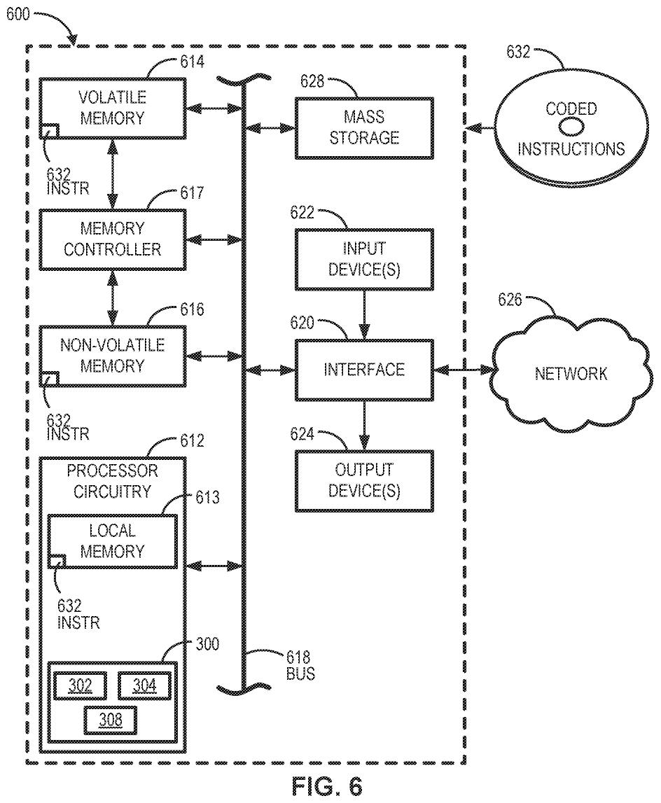

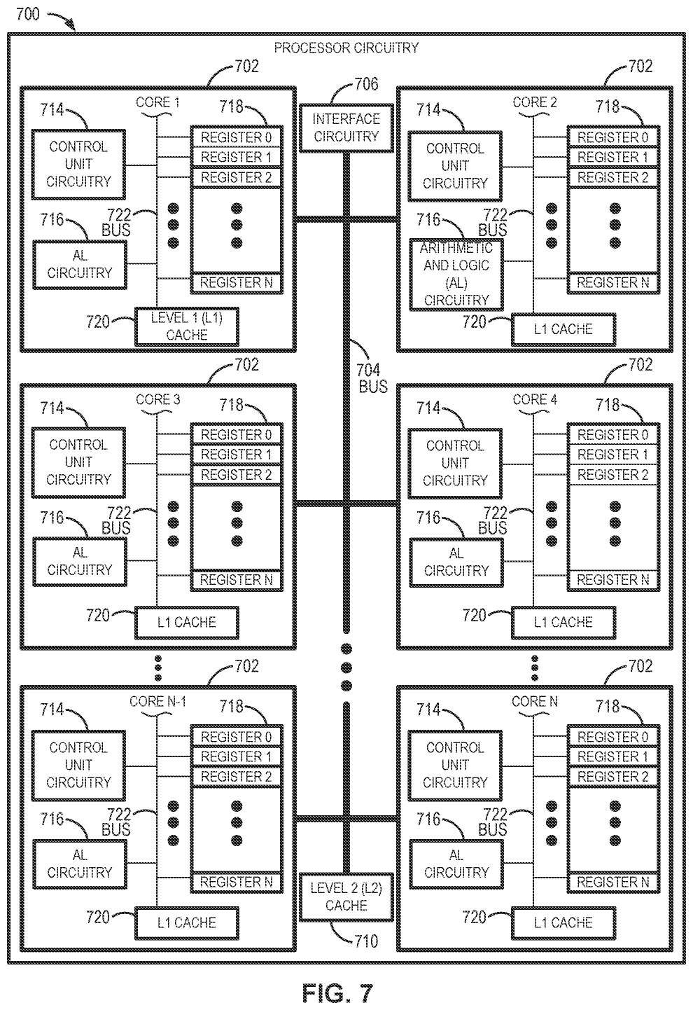

Flowchart(s) representative of example machine readable instructions, which may be executed by programmable circuitry to implement and/or instantiate the load balancer control system 300 of FIG. 3 and/or representative of example operations which may be performed by programmable circuitry to implement and/or instantiate the load balancer control system 300 of FIG. 3, are shown in FIGS. 4 and 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and 5, many other methods of implementing the example load balancer control system 300 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, MATLAB, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to manage computational tasks and/or workloads at an internode level of a distributed computing system, for example. The example machine-readable instructions and/or the example operations 400 of FIG. 4 begin at block 402, at which the compute node interface circuitry 302 retrieves, accessors and/or receives a batch of tasks, N. In some examples, the compute node interface circuitry 302 prompts a user to specify a maximum number of tasks per compute node, m, and the number of sets, k. In some examples, the compute node interface circuitry 302 retrieves the batch of tasks from a database and/or local storage.

In the illustrated example of FIG. 4, the compute node interface circuitry 302 and/or the internode balancer circuitry 308 allocates and/or distributes the batch of tasks into sets, k (block 404). According to some examples disclosed herein, the compute node interface circuitry 302 and/or the internode balancer circuitry 308 divides the batch of tasks equally amongst the sets. In other examples, the compute node interface circuitry 302 and/or the internode balancer circuitry 308 distributes the batch of tasks in an uneven manner between the sets.

At block 406, the example compute node interface circuitry 302 and/or the internode balancer circuitry 308 distributes and/or provides the sets to compute nodes (e.g., the compute nodes 108, the intranode balancer circuitry 304 of each of the respective compute nodes, etc.) and, additionally or alternatively, if there are remainder sets (e.g., the quantity of the sets is greater than the quantity of compute nodes), then the compute node interface circuitry 302 and/or the internode balancer circuitry 308 provides the remainder sets to a set queue. In some examples, the sets provided to the compute nodes is based on a ratio of the number of the compute nodes to a number of computational tasks.

At block 408, the example intranode balancer circuitry 304 causes and/or directs individual ones of the compute nodes to compute and/or perform the computational tasks, as described in greater detail below in connection with FIG. 5. In this example, the instructions of block 408 (shown in FIG. 5) are performed by each of the compute nodes. In some examples, the individual compute nodes perform (e.g., automatically perform) the computational tasks based on receiving the same.

At block 410, the example internode balancer circuitry 308 monitors the compute nodes for completion of the sets of computational tasks (block 410). In some examples, the internode balancer circuitry 308 transfers the remainder sets (e.g., queued sets) to the compute nodes based on the monitoring of the compute nodes. In this example, the internode balancer circuitry 308 monitors completion of the computational tasks of the sets across the compute nodes (e.g., the entirety of the compute nodes).

Additionally, the internode balancer circuitry 308 determines and monitors whether all the sets have been completed (block 412). In other words, the internode balancer circuitry 308 determines whether all of the sets have been completed by the compute nodes (block 412).

If all the sets are not complete (block 412), the process returns to block 406 such that queued remainder sets can be provided to the computer nodes as the computer nodes become available. Based on a determination that all the sets are completed (block 412), the internode balancer circuitry 308 ceases the monitoring of the compute nodes (block 416). Once the sets are completed and the monitoring has ceased, the process ends. In some examples the example operations 400 ends and awaits a trigger to repeat (e.g., a manual trigger, a time-based trigger, an iteration count trigger, a reception of a batch of computational tasks, etc.).

At block 418, in some examples, the compute node interface circuitry 302 and/or the internode balancer circuitry 308 provides an indication of completion. In some such examples, the indication provided by the compute node interface circuitry 302 can be a flag and/or alert.

FIG. 5 is a flowchart representative of example machine readable instructions and/or example operations 408 of FIG. 4 that may be executed, instantiated, and/or performed by programmable circuitry to manage performance of computational tasks and/or workloads at the intranode level. In particular, the example machine-readable instructions and/or the example operations 408 of FIG. 5 are performed at each of the individual compute nodes (e.g., the compute nodes 108). The example machine-readable instructions and/or the example operations 408 of FIG. 5 begin at block 502, at which the compute node interface circuitry 302 provides the compute node with the set and, in turn, the example intranode balancer circuitry 304 provides computational tasks of the set to a task queue. The example intranode balancer circuitry 304 can be implemented on each of the compute nodes.

The example compute node interface circuitry 302 and/or the example intranode balancer circuitry 304 causes the compute node to perform, compute and/or process the tasks of the set (e.g., first ones of tasks of the set) (block 504). According to some examples disclosed herein, the intranode balancer circuitry 304 assigns the computational tasks of the set to computational resources (e.g., processor threads, processing resources, computing units, processors, computing hardware, etc.) of the compute node.

At block 506, the example intranode balancer circuitry 304 monitors the aforementioned computational resources of the compute node for completion of the computational tasks. In some examples, the intranode balancer circuitry 304 monitors the compute node for completion of the computational tasks and transfers queued ones of the computational tasks to and/or between computational resources of the compute node based on the monitoring of the compute node. According to some examples disclosed herein, the intranode balancer 304 monitors the computational tasks within the compute node.

In this example, at block 508, the intranode balancer 304 determines whether any of the computational tasks within the set are complete and, if any of the computational tasks are not complete, the process returns to block 506. Otherwise, the process proceeds to block 510.

When any of the computational tasks are completed (block 508), then the intranode balancer 304 determines whether there are computational tasks in the task queue (block 510). If there are computational tasks in the task queue (block 510), then the intranode balancer 304 transfers and/or distributes the remainder tasks to the available computing resource of the compute node (block 512) and the process returns to block 506. If there are no computational tasks in the task queue (block 510), the process of FIG. 5 ends/returns.

FIG. 6 is a block diagram of an example programmable circuitry platform 600 structured to execute and/or instantiate the example machine-readable instructions and/or the example operations of FIGS. 4 and 5 to implement the load balancer control system 300 of FIG. 3. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the compute node interface circuitry 302, the intranode balancer circuitry 304, and the internode balancer circuitry 308.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4 and 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4 and 5 to effectively instantiate the circuitry of FIG. 2 as logic circuits to perform operations corresponding to those machine readable instructions. In some such examples, the circuitry of FIG. 3 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an Arithmetic Logic Unit (ALU)) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations.

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

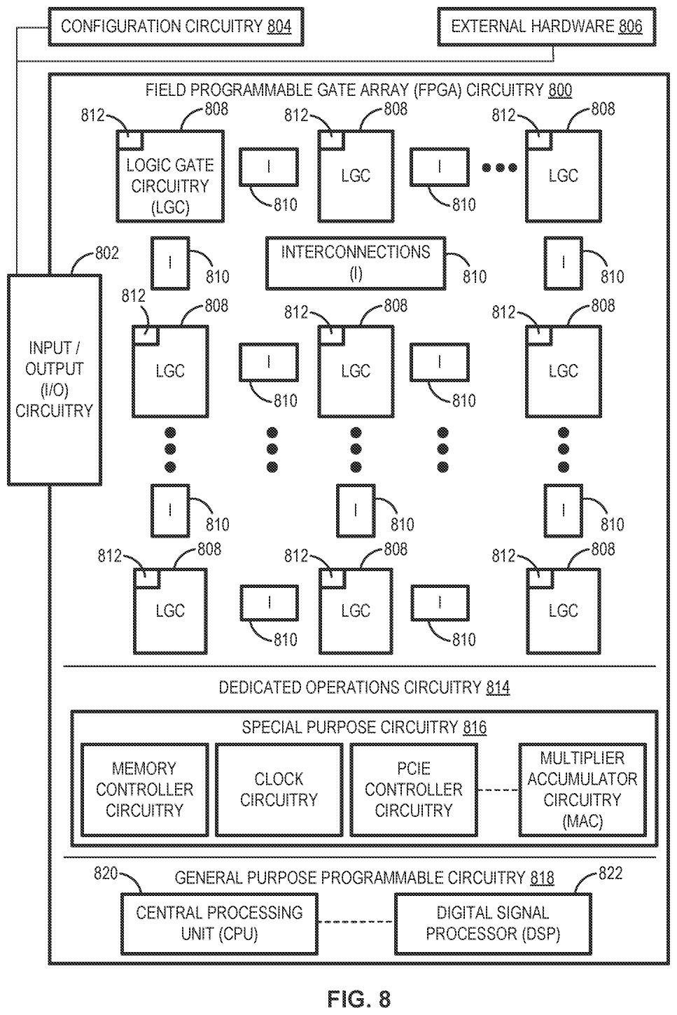

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowcharts of FIGS. 4 and 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 4 and 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 4 and 5. As such, the FPGA circuitry 800 may be configured and/or structured to effectively instantiate some or all of the operations/functions corresponding to the machine readable instructions of the flowcharts of FIGS. 4 and 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4 and 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4 and 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowcharts of FIGS. 4 and 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 4 and 5, and/or an ASIC may be configured and/or structured to perform third operation(s)/function(s) corresponding to a third portion of the machine readable instructions represented by the flowcharts of FIGS. 4 and 5.

It should be understood that some or all of the circuitry of FIG. 3 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 3 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

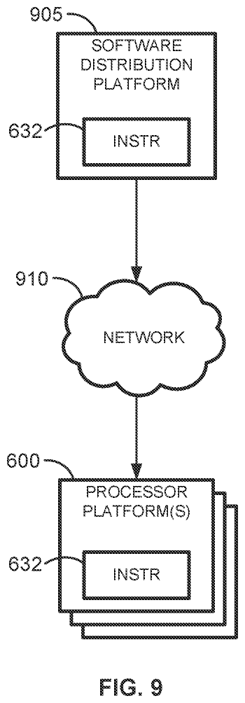

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 4 and 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIGS. 4 and 5, may be downloaded to the example programmable circuitry platform 600, which is to execute the machine readable instructions 632 to implement the controller circuitry. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods for multilevel balancing of computational tasks. Disclosed systems, apparatus, articles of manufacture, and methods improve the efficiency of using a computing device by reducing a need for manual user intervention and/or a significant number of user inputs typically necessitated to complete computational tasks. Further, examples disclosed herein reduce the overall time necessary for completion of computational tasks. Thus, computational resources are more efficiently employed and, consequently, energy resource usage can be decreased. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for multilevel balancing of computational tasks are disclosed herein. Further examples and combinations thereof include the following:

Example 1 includes an apparatus for multilevel distribution of computational tasks, the apparatus comprising interface circuitry to receive or access a batch of the computational tasks, machine readable instructions, and programmable circuitry to at least one of instantiate or execute the machine readable instructions to allocate the batch of the computational tasks into sets, distribute the sets to compute nodes, monitor the compute nodes for completion of the computational tasks, distribute ones of the computational tasks to computational resources of the respective compute nodes based on the monitoring of the completion of the computational tasks, monitor the compute nodes for completion of respective ones of the sets, distribute queued sets to the compute nodes based on the monitoring of the completion of the sets, and distribute queued tasks to the computational resources based on the monitoring of the completion of the tasks.

Example 2 includes the apparatus as defined in example 1, wherein the compute nodes are to provide an indication of completion of a set.

Example 3 includes the apparatus as defined in any of examples 1 or 2, wherein the programmable circuitry is to determine whether a quantity of the sets exceeds a quantity of available ones of the compute nodes, and when the quantity of the sets exceeds the quantity of available ones of the compute nodes, distribute at least one of the sets to the available ones of the compute nodes and provide remainder sets to a set queue to define the queued sets.

Example 4 includes the apparatus as defined in example 3, wherein the programmable circuitry is to transfer the queued sets to the compute nodes as the compute nodes become available.

Example 5 includes the apparatus as defined in any of examples 3 or 4, wherein the programmable circuitry is to provide the compute nodes with the queued sets such that the compute nodes are saturated with computational tasks.

Example 6 includes the apparatus as defined in any of examples 1 to 5, wherein a quantity of the sets provided to the compute nodes is based on a ratio of a number of the compute nodes to a number of tasks.

Example 7 includes the apparatus as defined in any of examples 1 to 6, wherein the programmable circuitry is to evaluate completion of the sets, and cease monitoring based on a determination of the completion.

Example 8 includes the apparatus as defined in any of examples 1 to 7, wherein the programmable circuitry is to provide an indication of the completion of the sets.

Example 9 includes a non-transitory machine readable storage medium comprising instructions to cause programmable circuitry to at least allocate a batch of computational tasks into sets, distribute the sets to compute nodes, monitor the compute nodes for completion of the computational tasks, distribute ones of the computational tasks between computational resources of the respective compute nodes based on the monitoring of the completion of the computational tasks, monitor the compute nodes for completion of respective ones of the sets, distribute queued sets to the compute nodes based on the monitoring of the completion of the sets, and distribute queued tasks to the computational resources based on the monitoring of the completion of the tasks.

Example 10 includes the non-transitory machine readable storage medium as defined in example 9, wherein the instructions cause the programmable circuitry to distribute the sets to the compute nodes based on a computational capability of ones of the compute nodes.

Example 11 includes the non-transitory machine readable storage medium as defined in any of examples 9 or 10, wherein the instructions cause the programmable circuitry to determine whether a quantity of the sets exceeds a quantity of available ones of the compute nodes, and when the quantity of the sets exceeds the quantity of available ones of the compute nodes, distribute at least one of the sets to the available ones of the compute nodes and provide remainder sets to a set queue to define the queued sets.

Example 12 includes the non-transitory machine readable storage medium as defined in example 11, wherein the instructions cause the programmable circuitry to transfer the queued sets to the compute nodes as the compute nodes become available.

Example 13 includes the non-transitory machine readable storage medium as defined in any of examples 11 or 12, wherein the instructions cause the programmable circuitry to provide the compute nodes with the remainder sets such that the compute nodes are saturated with computational tasks.

Example 14 includes the non-transitory machine readable storage medium as defined in any of examples 9 to 13, wherein the instructions cause the programmable circuitry to evaluate completion of the sets, and cease monitoring based on a determination of the completion.

Example 15 includes the non-transitory machine readable storage medium as defined in any of examples 9 to 14, wherein a quantity of the sets provided to the compute nodes is based on a ratio of a number of the compute nodes to a number of tasks.

Example 16 includes the non-transitory machine readable storage medium as defined in any of examples 9 to 15, wherein the programmable circuitry is to provide an indication of the completion of the sets.

Example 17 includes a method for multilevel distribution of computational tasks, the method comprising dividing, by executing instructions with programmable circuitry, a batch of the computational tasks into sets, distributing, by executing instructions with the programmable circuitry, the sets to compute nodes, monitoring, by executing instructions with the programmable circuitry, the compute nodes for completion of the computational tasks distributing, by executing instructions with the programmable circuitry, ones of the computational tasks between computational resources of the respective compute nodes based on the monitoring of the completion of the computational tasks monitoring, by executing instructions with the programmable circuitry, the compute nodes for completion of respective ones of the sets, distributing, by executing instructions with the programmable circuitry, queued sets to the compute nodes based on the monitoring of the completion of the sets, and distributing, by executing instructions with the programmable circuitry, queued tasks to the computational resources based on the monitoring of the completion of the tasks.

Example 18 includes the method as defined in example 17, further including determining, by executing instructions with the programmable circuitry, whether a quantity of the sets exceeds a quantity of available ones of the compute nodes, and, when the quantity of the sets exceeds the quantity of available ones of the compute nodes, distributing at least one of the sets to the available ones of the compute nodes and provide remainder sets to a set queue having the queued sets.

Example 19 includes the method as defined in example 18, further including providing, by executing instructions with the programmable circuitry, the compute nodes with the queued sets such that the compute nodes are saturated with computational tasks.

Example 20 includes the method as defined in any of examples 17 to 19, further including evaluating, by executing instructions with the programmable circuitry, completion of the sets, and ceasing monitoring based on a determination of the completion.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus for multilevel distribution of computational tasks, the apparatus comprising:
interface circuitry to receive or access a batch of the computational tasks;
machine readable instructions; and
programmable circuitry to at least one of instantiate or execute the machine readable instructions to:
allocate the batch of the computational tasks into sets,
distribute the sets to compute nodes,
monitor the compute nodes for completion of the computational tasks,
distribute ones of the computational tasks to computational resources of the respective compute nodes based on the monitoring of the completion of the computational tasks,
monitor the compute nodes for completion of respective ones of the sets,
distribute queued sets to the compute nodes based on the monitoring of the completion of the sets, and
distribute queued tasks to the computational resources based on the monitoring of the completion of the tasks.

2. The apparatus as defined in claim 1, wherein the compute nodes are to provide an indication of a completion of a set.

3. The apparatus as defined in claim 1, wherein the programmable circuitry is to determine whether a quantity of the sets exceeds a quantity of available ones of the compute nodes, and when the quantity of the sets exceeds the quantity of available ones of the compute nodes, distribute at least one of the sets to the available ones of the compute nodes and provide remainder sets to a set queue to define the queued sets.

4. The apparatus as defined in claim 3, wherein the programmable circuitry is to transfer the queued sets to the compute nodes as the compute nodes become available.

5. The apparatus as defined in claim 3, wherein the programmable circuitry is to provide the compute nodes with the queued sets such that the compute nodes are saturated with computational tasks.

6. The apparatus as defined in claim 1, wherein a quantity of the sets provided to the compute nodes is based on a ratio of a number of the compute nodes to a number of tasks.

7. The apparatus as defined in claim 1, wherein the programmable circuitry is to evaluate completion of the sets, and cease monitoring based on a determination of the completion.

8. The apparatus as defined in claim 1, wherein the programmable circuitry is to provide an indication of the completion of the sets.

9. A non-transitory machine readable storage medium comprising instructions to cause programmable circuitry to at least:
allocate a batch of computational tasks into sets;
distribute the sets to compute nodes;
monitor the compute nodes for completion of the computational tasks;
distribute ones of the computational tasks between computational resources of the respective compute nodes based on the monitoring of the completion of the computational tasks;
monitor the compute nodes for completion of respective ones of the sets;
distribute queued sets to the compute nodes based on the monitoring of the completion of the sets; and
distribute queued tasks to the computational resources based on the monitoring of the completion of the tasks.

10. The non-transitory machine readable storage medium as defined in claim 9, wherein the instructions cause the programmable circuitry to distribute the sets to the compute nodes based on a computational capability of ones of the compute nodes.

11. The non-transitory machine readable storage medium as defined in claim 9, wherein the instructions cause the programmable circuitry to determine whether a quantity of the sets exceeds a quantity of available ones of the compute nodes, and when the quantity of the sets exceeds the quantity of available ones of the compute nodes, distribute at least one of the sets to the available ones of the compute nodes and provide remainder sets to a set queue to define the queued sets.

12. The non-transitory machine readable storage medium as defined in claim 11, wherein the instructions cause the programmable circuitry to transfer the queued sets to the compute nodes as the compute nodes become available.

13. The non-transitory machine readable storage medium as defined in claim 11, wherein the instructions cause the programmable circuitry to provide the compute nodes with the remainder sets such that the compute nodes are saturated with computational tasks.

14. The non-transitory machine readable storage medium as defined in claim 9, wherein the instructions cause the programmable circuitry to evaluate completion of the sets, and cease monitoring based on a determination of the completion.

15. The non-transitory machine readable storage medium as defined in claim 9, wherein a quantity of the sets provided to the compute nodes is based on a ratio of a number of the compute nodes to a number of tasks.

16. The non-transitory machine readable storage medium as defined in claim 9, wherein the programmable circuitry is to provide an indication of the completion of the sets.

17. A method for multilevel distribution of computational tasks, the method comprising:
dividing, by executing instructions with programmable circuitry, a batch of the computational tasks into sets;
distributing, by executing instructions with the programmable circuitry, the sets to compute nodes;
monitoring, by executing instructions with the programmable circuitry, the compute nodes for completion of the computational tasks
distributing, by executing instructions with the programmable circuitry, ones of the computational tasks between computational resources of the respective compute nodes based on the monitoring of the completion of the computational tasks
monitoring, by executing instructions with the programmable circuitry, the compute nodes for completion of respective ones of the sets;
distributing, by executing instructions with the programmable circuitry, queued sets to the compute nodes based on the monitoring of the completion of the sets; and
distributing, by executing instructions with the programmable circuitry, queued sets to the computational resources based on the monitoring of the completion of the tasks.

18. The method as defined in claim 17, further including determining, by executing instructions with the programmable circuitry, whether a quantity of the sets exceeds a quantity of available ones of the compute nodes, and, when the quantity of the sets exceeds the quantity of available ones of the compute nodes, distributing at least one of the sets to the available ones of the compute nodes and provide remainder sets to a set queue having the queued sets.

19. The method as defined in claim 18, further including providing, by executing instructions with the programmable circuitry, the compute nodes with the queued sets such that the compute nodes are saturated with computational tasks.

20. The method as defined in claim 17, further including evaluating, by executing instructions with the programmable circuitry, completion of the sets, and ceasing monitoring based on a determination of the completion.
